(19) United States
(12) Patent Application Publication
(10) Pub. No.: US 2007/0035687 A1
(43) Pub. Date: Feb. 15, 2007

(54) Display device

(76) Inventors: Ryutaro Oke, Chiba (JP); Kenta Kamoshida, Tokorozawa (JP); Ikuko Mori, Chiba (JP)

Correspondence Address: REED SMITH LLP, Suite 1400, 3110 Fairview Park Drive, Falls Church, VA, 22042, US

(21) Appl. No.: 11/502,458

(22) Filed: Aug. 11, 2006

(30) Foreign Application Priority Data
Aug. 12, 2005 (JP) 2005-234352

(51) Int. Cl. G02F 1/1343

(52) U.S. Cl. 349/143

(57) ABSTRACT

The present invention realizes a liquid crystal display device corresponding to high frequency. In a display device in which a plurality of drain electrode lines and a plurality of gate electrode lines are arranged in a matrix array, a pixel region is defined at a portion which is surrounded by two neighboring drain electrode lines and two neighboring gate electrode lines, each pixel region includes a TFT element, and a mass of pixel regions form a display region, each time the drain electrode line traverses the gate electrode line in the extending direction of the drain electrode line, the arrangement direction of TFT elements with respect to the drain electrode line is inverted, and a TFT element is arranged outside the display region each time the drain electrode line traverses two gate electrode lines.

The present application claims priority from Japanese application JP2005-200314 filed on Jul. 8, 2005, the content of which is hereby incorporated by reference into this application.

### BACKGROUND OF THE INVENTION

1. Field of the Invention

The present invention relates to a display device, and more particularly to a technique which is effectively applicable to a display device on which a TFT element is arranged for each pixel.

2. Description of the Related Art

Conventionally, as a display device of a television receiver set, there has been known a liquid crystal display device which uses a liquid crystal display panel.

The liquid crystal display panel is a display panel which seals a liquid crystal material between a pair of substrates. Here, on one substrate, for example, a TFT element and a pixel electrode are arranged for each pixel. Further, on another substrate, for example, a color filter is arranged at a position which faces the pixel electrode.

Here, the circuit constitution on the substrate on which the TFT elements and the like are arranged, for example, as shown in FIG. 31, in the display device having the number of dots in an effective display area which is expressed by lateral m dots×longitudinal n dots, (3 m+1) pieces of drain electrode lines DL and (n+1) pieces of gate electrode lines GL are arranged. Here, FIG. 31 shows a case in which one dot is constituted of three pixels consisting of a R pixel, a G pixel and a B pixel. Further, in FIG. 31, the drain electrode line DL_{3 m+1} on a left end of a paper surface and the gate electrode line GLₙ₊₁ on a lower end on the paper surface are dummies.

Further, in this liquid crystal display panel, for example, as shown in FIG. 31, with respect to the TFT elements of the respective pixels which are arranged along the extending direction of the drain electrode line DL, all TFT elements are connected with the same drain electrode line. For example, all of the TFT elements of the R pixel which are arranged along the drain electrode line DL₁ are connected with the drain electrode line DL₁.

On the other hand, an example in which TFTs are arranged alternately along a neighboring drain electrode line is described in Patent Document 1.

Patent Document 1: JP-A-10-90712

### SUMMARY OF THE INVENTION

In the liquid crystal display device of the above-mentioned television receiver set, there has been a strong demand for a higher refresh rate for suppressing flickering of a screen or for enhancing a display performance of a motion picture.

However, when the constitution shown in FIG. 31 is adopted as a circuit constitution on the display panel, along with the rapid progress of the refresh rate, the shortage of writing in the TFT elements occurs thus giving rise to a drawback that an image quality is deteriorated.

Accordingly, it is an object of the present invention to provide a technique which can reduce the deterioration of an image quality attributed to a high frequency operation of a liquid crystal display device, for example.

The above-mentioned and other objects and novel features of the present invention will become apparent by the description of this specification and attached drawings.

To briefly explain the summary of the invention disclosed in this specification, it is as follows.

(1) The present invention provides a display device which includes a display panel on which a TFT element and a pixel electrodes are arranged for each pixel, wherein the display panel arranges, outside one end portion of an effective display region in the extending direction of gate electrode lines out of end portions of the effective display region, first dummy pixels having TFT elements which are connected with the even-numbered gate electrode lines counted from one end portion of the effective display region in the extending direction of drain electrode lines, the display panel arranges, outside another end portion of the effective display region in the extending direction of gate electrode lines out of the end portions of the effective display region, second dummy pixels having TFT elements which are connected with the odd-numbered gate electrode lines counted from the one end portion of the effective display region in the extending direction of the drain electrode lines, and the TFT elements of the respective pixels which are arranged on both sides of the drain electrode line are alternately connected with each drain electrode line in the extending direction of the drain electrode line, and the TFT elements which are arranged in the inside of the effective display region and the first or the second dummy pixels are alternately connected with each drain electrode line at the end portion of the effective display region in the extending direction of the gate electrode lines along the extending direction of the drain electrode line.

(2) In the above-mentioned means (1), the end portion of the effective display region on which the first dummy pixels are arranged may constitute an input end side of the gate electrode lines.

(3) In the above-mentioned means (1) or (2), the first and the second dummy pixels may have the same constitution as the pixels within the effective display region.

(4) In the above-mentioned means (1) or (2), the first and the second dummy pixels may include only the TFT elements.

(5) In any one of the above-mentioned means (1) to (4), a dummy drain electrode line may be provided outside the first or the second dummy pixels.

(6) In any one of the above-mentioned means (1) to (5), a third dummy pixel may be arranged between the first dummy pixels or between the second dummy pixels.

(7) In the above-mentioned means (6), the third dummy pixel may have a dummy electrode layer on a same conductive layer as the pixel electrodes of the pixels within the effective display region.

(8) In the above-mentioned means (7), the third dummy element may include a TFT element which is connected with the dummy electrode line and the dummy electrode layer.

(9) The present invention also provides a display device in which a plurality of drain electrode lines and a plurality of gate electrode lines are arranged in a matrix array, a pixel region is defined at a portion which is surrounded by two neighboring drain electrode lines and two neighboring gate electrode lines, each pixel region includes a TFT element, and a mass of pixel regions form a display region, wherein each time the drain electrode line traverses the gate electrode line in the extending direction of the drain electrode line, the arrangement direction of TFT elements with respect to the drain electrode line is inverted, and a TFT element is arranged outside the display region each time the drain electrode line traverses two gate electrode lines.

(10) In the above-mentioned means (9), a region where the TFT element may be arranged each time the drain electrode line traverses two gate electrode lines is shielded from light.

(11) In the above-mentioned means (9) or (10), a region where the TFT element is arranged each time the drain electrode line traverses two gate electrode lines may be displaced from each other between the left outside and the right outside of the display region by an amount corresponding to one gate electrode line.

(12) In any one of the above-mentioned means (9) to (11), a signal having the same polarity may be applied to the drain electrode line during 1 frame period.

(13) In the above-mentioned means 12, signals having polarities opposite to each other may be applied to two neighboring drain electrode lines.

(14) The present invention also provides a display device in which a plurality of drain electrode lines and a plurality of gate electrode lines are arranged in a matrix array, a pixel region is defined at a portion which is surrounded by two neighboring drain electrode lines and two neighboring gate electrode lines, each pixel region includes a TFT element, and a mass of pixel regions form a display region, wherein each time the drain electrode line traverses the gate electrode line in the extending direction of the drain electrode line, the arrangement direction of TFT elements with respect to the drain electrode line is inverted, and a signal of the same polarity is applied to the drain electrode line during 1 frame period, and signals having polarities opposite to each other are applied to two neighboring drain electrode lines.

The display device of the present invention can be driven such that signals having polarities opposite to each other with respect to a common potential are applied to neighboring drain electrode lines over 1 frame. Here, since the TFT elements are connected with the drain electrode line alternately, it is possible to process signals which are written in the pixel electrodes of the pixels in a matrix array in dot inversion which allows the neighboring pixels to invert polarities from each other. Due to such a constitution, it is possible to eliminate the flickering which the conventional frame inversion suffers from. Further, due to the feature of the frame inversion that an interval of changeover of polarities is long, the number of charging/discharging to the drain electrode line is drastically decreased comparing to the dot inversion thus enabling the driving at a high refresh rate, for example, at a frame rate equal to or more than 100 Hz, and more specifically, at a frame rate of 120 Hz.

On the other hand, in such an arrangement, it is found out that unless a particular consideration is taken into account with respect to the outermost drain electrode line which is used for display, a capacitance of the outermost drain electrode line and capacitances of other drain electrode lines largely differ from each other and hence, the brightness difference arises between the outermost drain electrode line and other drain electrode lines.

According to the present invention, in the display device which can realize the dot inversion in display while adopting the frame inversion with respect to the potentials of the drain electrode lines, it is possible to realize a particular and outstanding advantage that it is possible to obviate the occurrence of brightness irregularities of the outermost peripheral display line out of the display lines in the direction perpendicular to the gate lines.

To obtain such advantages, for example, as in the case of the means (1), the first and the second dummy pixels are arranged outside the effective display region. Further, to each drain electrode line, for example, the TFT elements of pixels which are arranged on the right side with respect to the drain electrode line and the TFT elements of pixels which are arranged on the left side with respect to the drain electrode line are alternately connected. Here, with respect to the first and the second dummy pixels, for example, as in the case of the means (2), on the input end side of the gate electrode lines, the first dummy pixels which include the TFT elements which are connected with the even-numbered gate electrode lines are arranged. Further, the first and the second dummy elements may have the same constitution as the pixels within the effective display region as in the case of the means (3) or may have only the TFT elements as in the case of the means (4).

Further, when the first and the second dummy elements are arranged, to the drain electrode line to which the TFT elements of the respective dummy pixels are connected, at the timing that a write signal is applied to the respective dummy pixels, for example, a signal for black display is applied. Further, with respect to the first dummy pixels, a signal which is equal to a signal which is applied to the pixels within the one-step-preceding display region may be applied the first dummy pixels, while with respect to the second dummy pixels, a signal which is equal to a signal which is applied to the pixels within the one-step-succeeding display region may be applied the second dummy pixels.

Here, as in the case of (5), the dummy drain electrode line may be added. To the dummy drain electrode line, for example, a common signal may be applied. Further, the dummy drain electrode line may be added to only the outside of the first dummy pixels, or may be added to only the outside of the second dummy pixels, or may be added to both outsides of the first dummy pixels and the second dummy pixels.

Further, in arranging the first and the second dummy pixels, the respective dummy pixels are arranged every one other pixel. Accordingly, a step is generated between the dummy pixels and hence, for example, in a rubbing step for forming an orientation film, there exists a possibility that the irregularities in rubbing strength attributed to the step are generated. Accordingly, as in the case of the means (6), for example, it is preferable to provide the third dummy pixels so as to reduce the step. Here, the third dummy pixel may include only the dummy electrode layer as in the case of the means (7) or may include the dummy electrode layer and the dummy TFT element as in the case of the means (8), for example.

Further, the constitution of the above-mentioned means (1) may be also expressed as in the case of above-mentioned means (9) or the means (11). The region where the TFT element is arranged each time the drain electrode line traverses two gate electrode lines in the means (9) corresponds to the region where the fist dummy pixel or the second dummy pixel is arranged. Accordingly, as in the case of the means (10), it is preferable to shield the region where the TFT element is arranged each time the drain electrode line traverses two gate electrode lines from light.

Further, in the display device having the constitution of any one of the means (9) to the means (11), the signal is applied to the drain electrode line as in the case of the means (12), the means (13) or the means (14), for example.

### BRIEF DESCRIPTION OF THE DRAWINGS

FIG. 1 is a schematic view showing one example of the schematic constitution of a display panel which a display device to which the present invention is applied includes and also is a front view showing a constitutional example of a liquid crystal display panel;

FIG. 2 is a cross-sectional view taken along a line A-A′ in FIG. 1;

FIG. 3 is a schematic view showing the circuit constitution of a TFT substrate of one embodiment according to the present invention;

FIG. 4 is a view showing one example of a timing chart of a signal applied to a drain electrode line DL₁ of the display panel of the embodiment;

FIG. 5 is a view showing one example of a timing chart of a signal applied to a drain electrode line DL_{3 m+1} of the display panel of the embodiment;

FIG. 6 is a view showing another example of a timing chart of a signal applied to a drain electrode line DL₁ of the display panel of the embodiment;

FIG. 7 is a view showing another example of a timing chart of a signal applied to a drain electrode line DL_{3 m+1} of the display panel of the embodiment;

FIG. 8 is a schematic view showing a constitutional example of a TFT substrate to which the circuit constitution of the embodiment is applied and also is an enlarged plan view of an end portion of an effective display region;

FIG. 9 is a cross-sectional view taken along a line B-B′ in FIG. 8;

FIG. 10 is a schematic view for explaining a first modification of the embodiment and also is a view showing the circuit constitution of a TFT substrate;

FIG. 11 is a schematic view for explaining a second modification of the embodiment and also is a view showing the circuit constitution of a TFT substrate;

FIG. 12 is an enlarged plan view showing a constitutional example of the TFT substrate to which the circuit constitution shown in FIG. 11 is applied;

FIG. 13 is a cross-sectional view taken along a line C-C′ in FIG. 12;

FIG. 14 is a schematic view for explaining a third modification of the embodiment and also is a view showing the circuit constitution of a TFT substrate;

FIG. 15 is a schematic view for explaining the third modification of the embodiment and also is a view showing another example of the circuit constitution of a TFT substrate;

FIG. 16 is a schematic view for explaining the third modification of the embodiment and also is a view showing another example of the circuit constitution of a TFT substrate;

FIG. 17 is an enlarged plan view showing a constitutional example of the TFT substrate to which the circuit constitution shown in FIG. 15 is applied;

FIG. 18 is a cross-sectional view taken along a line C-C′ in FIG. 17;

FIG. 19 is a schematic view for explaining a fourth modification of the embodiment and also is a view showing the circuit constitution of a TFT substrate;

FIG. 20 is a schematic view for explaining the fourth modification of the embodiment and also is a view showing another example of the circuit constitution of a TFT substrate;

FIG. 21 is a schematic view for explaining the fourth modification of the embodiment and also is a view showing another example of the circuit constitution of a TFT substrate;

FIG. 22 is an enlarged plan view showing a constitutional example of the TFT substrate to which the circuit constitution shown in FIG. 20 is applied;

FIG. 23 is a cross-sectional view taken along a line D-D′ in FIG. 22;

FIG. 24 is an enlarged plan view showing a constitutional example of the TFT substrate to which the circuit constitution shown in FIG. 20 is applied;

FIG. 25 is a cross-sectional view taken along a line F-F′ in FIG. 24;

FIG. 26 is a schematic view for explaining a fifth modification of the embodiment and also is a view showing the circuit constitution of a TFT substrate;

FIG. 27 is a schematic view for explaining the fifth modification of the embodiment and also is a view showing another example of the circuit constitution of a TFT substrate;

FIG. 28 is a schematic view for explaining the fifth modification of the embodiment and also is a view showing another example of the circuit constitution of a TFT substrate;

FIG. 29 is an enlarged plan view showing a constitutional example of the TFT substrate to which the circuit constitution shown in FIG. 27 is applied;

FIG. 30 is a cross-sectional view taken along a line G-G′ in FIG. 29; and

FIG. 31 is a view showing the circuit constitution of a conventional TFT substrate.

### DESCRIPTION OF THE PREFERRED EMBODIMENTS

Hereinafter, the present invention is explained in conjunction with embodiments by reference to drawings.

Here, in all drawings for explaining the embodiments, parts having identical functions are indicated by same symbols and the repeated explanation is omitted.

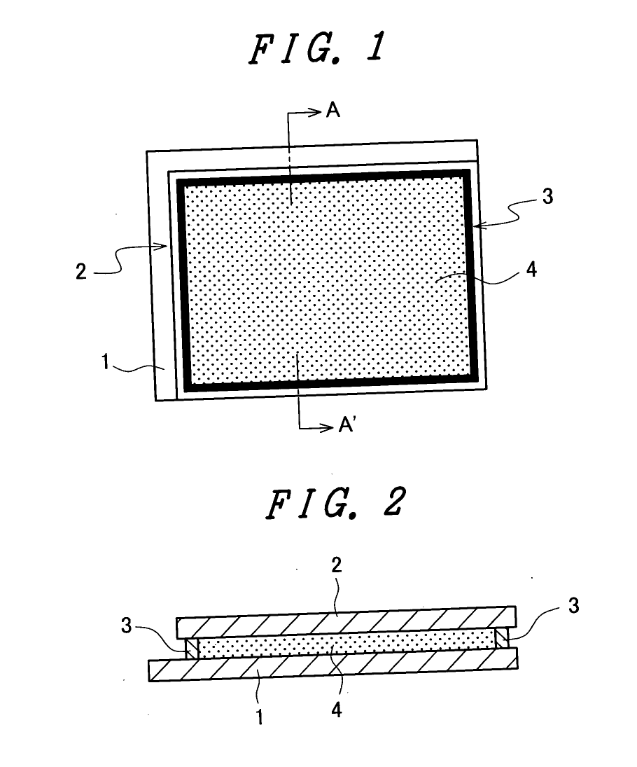

FIG. 1 and FIG. 2 are schematic views showing one example of the schematic constitution of a display panel provided to a display device to which the present invention is applied. FIG. 1 is a front view showing a constitutional example of a liquid crystal display panel, and FIG. 2 is a cross-sectional view taken along a line A-A′ in FIG. 1.

The display device to which the present invention is applicable is, for example, a liquid crystal display device which includes a liquid crystal display panel on which TFT elements are arranged such that the TFT is provided to each unit. The liquid crystal display panel is a display panel in which, for example, as shown in FIG. 1 and FIG. 2, a pair of substrates 1, 2 is adhered to each other using an annular sealing member 3 and a liquid crystal material 4 is sealed in a space surrounded by the respective substrates 1, 2 and the sealing member 3. Here, on one substrate 1, the TFT elements and pixel electrodes are arranged, while on another substrate 2, color filters are arranged at positions which face the pixel electrodes in an opposed manner.

Further, the liquid crystal display device having the liquid crystal display panel shown in FIG. 1 and FIG. 2 includes a pair of polarizers which are arranged to sandwich the liquid crystal display panel therebetween, a backlight unit which is arranged behind the liquid crystal display panel sandwiched between the polarizers and the like. Here, the liquid crystal display device according to the present invention may have same constitution as a conventional liquid crystal display device with respect to the basic constitution and hence, the detailed explanation is omitted.

The circuit constitution of the substrate 1 on which the TFT elements and the pixel electrodes are arranged in the display device provided with such a liquid crystal display panel as shown in FIG. 1 and FIG. 2 (hereinafter, referred to as TFT substrate) is explained hereinafter.

### EMBODIMENT

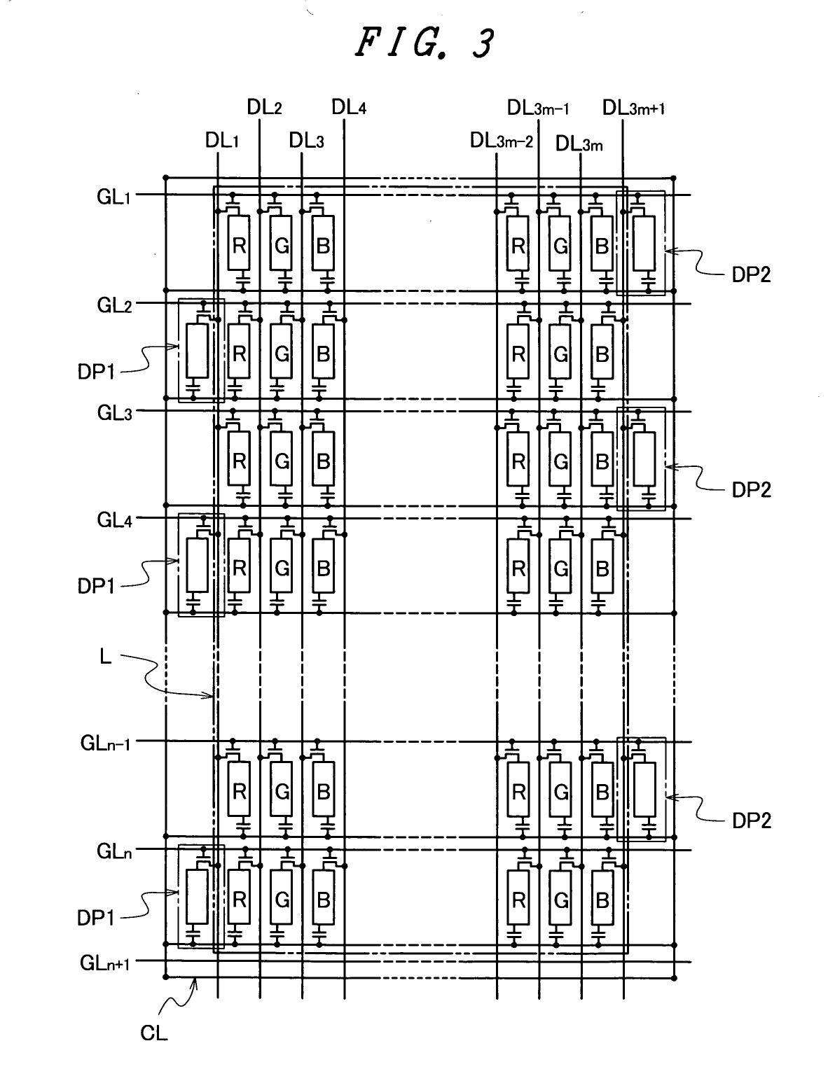

FIG. 3 is a schematic view showing the circuit constitution of a TFT substrate of one embodiment according to the present invention.

The TFT substrate 1 of this embodiment includes, for example, as shown in FIG. 3, n+1 pieces of gate electrode lines GL which extend in the horizontal direction and are arranged in parallel in the vertical direction, 3 m+1 pieces of drain electrode lines DL which extend in the vertical direction and are arranged in parallel in the horizontal direction, and common signal lines CL which extend in the horizontal direction and are arranged in parallel in the vertical direction. Here, the explanation is made hereinafter by referring to an example in which the common signal lines CL are provided. However, the present invention is also directly applicable to an example in which the common signal lines CL are not provided without modification.

Further, at an intersecting point of each gate electrode line GL and each drain electrode line DL, a TFT element which is connected with the gate electrode line GL and the drain electrode line DL is arranged. Here, a source electrode of the TFT element is connected with the pixel electrode PX. Further, the pixel electrode PX forms a capacitive element between the pixel electrode PX and a common electrode (not shown in the drawing) which is connected with the common signal line CL. As an example in which a common electrode which is connected with the common signal line CL is not present, the constitution which adopts a so-called vertical electric field method in which a common electrode is formed on the substrate 2 which faces the TFT substrate 1 and a capacity is formed between the common electrode and the pixel electrodes PX is named.

Here, an example of the TFT substrate shown in FIG. 3 is a TFT substrate which is used for a color liquid crystal display panel, wherein one dot on an effective display region L is formed of three pixels arranged in the horizontal direction, that is, an R pixel having a pixel electrode PX marked with R, a G pixel having a pixel electrode PX marked with G and a B pixel having a pixel electrode PX marked with B.

In the effective display region L, the TFT elements are alternately connected with the drain electrode line DL. That is, the pixels which are controlled by the odd-numbered gate electrode line GL are connected with the odd-numbered drain electrode line DL, and the pixels which are controlled by the gate even-numbered electrode line GL are connected with the even-numbered drain electrode line DL.

Further, in the TFT substrate 1 of this embodiment, out side end portions of the effective display region L in the extending direction of the gate electrode lines GL, dummy pixels are arranged. Here, outside the end portion on a side on which the drain electrode line DL₁ is arranged, first dummy pixels DP1 each of which has a TFT element thereof connected with the even-numbered gate electrode line GL is arranged. On the other hand, outside the end portion on a side on which the drain electrode line DL_{3 m+1} is arranged, second dummy pixels DP2 each of which has a TFT element thereof connected with the odd-numbered gate electrode line GL is arranged. Here, the first and the second dummy pixels DP1, DP2 have the same constitution as respective pixels within the effective display region L.

Further, to each drain electrode line DL, TFT elements which are arranged on the right side of the drain electrode line DL and the TFT elements which are arranged on the left side of the drain electrode line DL are alternately arranged along the extending direction of the drain electrode line DL.

Here, when the drain electrode lines DL are arranged with numbers from the left side, on the left side line which is closest to the effective display region L, the dummy pixels which are controlled by the even-numbered gate electrode line GL are arranged in a state that the connection order of the TFT elements of the dummy pixels becomes equal to the connection order of the TFT elements of the pixels within the effective display region L. Due to such a constitution, the number of the TFT elements which are connected with the drain electrode line DL₁ arranged on the left outermost side of the effective display region L becomes equal to the number of the TFT elements which are connected with another drain electrode lines within the effective display region L and hence, a load of the drain electrode line DL₁ becomes equal to a load of another drain electrode line within the effective display region L whereby it is possible to prevent the generation of brightness change in the display pixels connected with the drain electrode line DL₁ with respect to the pixels connected with another drain electrode line within the effective display region L.

In the same manner, on the right side line which is closest to the effective display region L, the dummy pixels which are controlled by the odd-numbered gate electrode line GL are arranged in a state that the connection order of the TFT elements of the dummy pixels becomes equal to the connection order of the TFTs of the pixels within the effective display region L. Due to such a constitution, the number of the TFT elements which are connected with the drain electrode line DL_{3 m+1} arranged on the right outermost side of the effective display region L becomes equal to the number of the TFT elements which are connected with another drain electrode line within the effective display region L and hence, a load of DL_{3 m+1} becomes equal to a load of another drain electrode line whereby it is possible to prevent the generation of brightness change in the display pixels connected with the drain electrode line DL_{3 m+1} with respect to the pixels connected with another drain electrode line within the effective display region L.

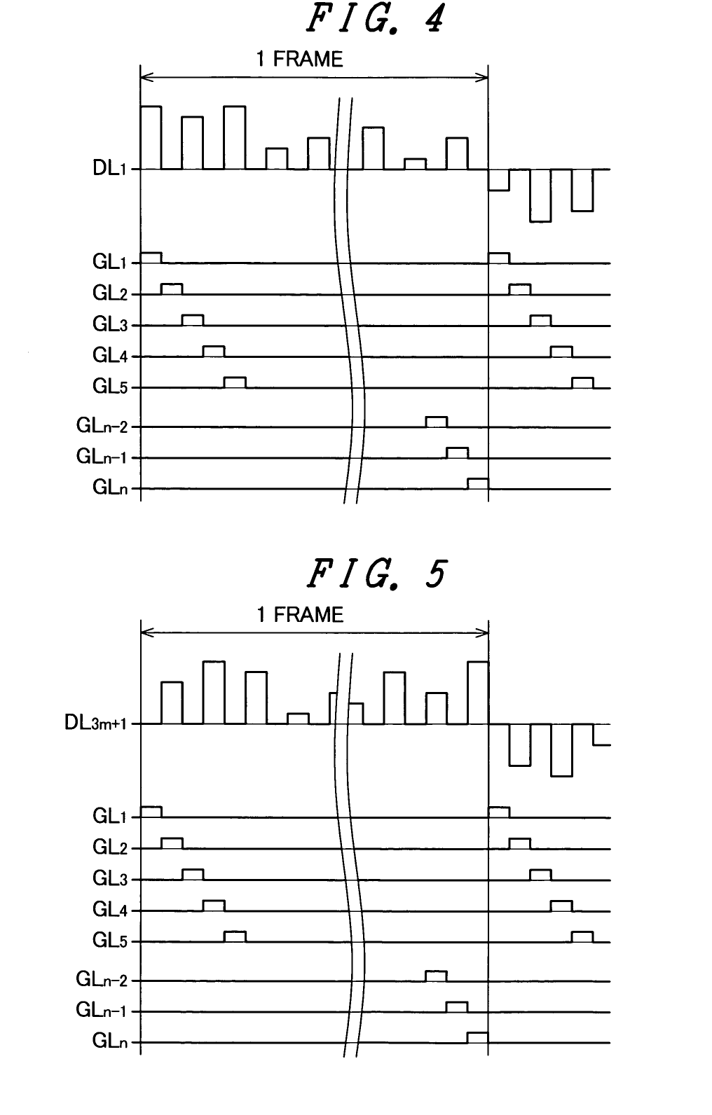

FIG. 4 is a view showing one example of a timing chart of signals which are applied to the drain electrode line DL₁ of the display panel of this embodiment. Further, FIG. 5 is a view showing one example of a timing chart of signals which are applied to the drain electrode line DL_{3 m+1} of the display panel of this embodiment.

When the circuit having the constitution shown in FIG. 3 is provided to the TFT substrate 1, to the drain electrode line DL₁ on the end-portion-side on which the first dummy pixels DP1 are arranged, the TFT elements of the R pixels within the the effective display region L and the TFT elements of the first dummy pixels DP1 are alternately connected along the extending direction of the drain electrode line DL₁. Here, assuming that a write signal is applied to the drain electrode line DL₁ from an upper side of a paper surface, with respect to the applied signals, for example, as shown in FIG. 4, the write signal is applied to the R pixels at timing that the gate signal is applied to the odd-numbered gate electrode lines GL₁, GL₃, GL₅ and a signal which makes the dummy pixels DP1 display black color is applied at timing that the gate signal is applied to the even-numbered gate electrode lines GL₂, GL₄.

On the other hand, to the drain electrode line DL_{3 m+1} on the end-portion-side on which the second dummy pixels DP2 are arranged, the TFT elements of the second dummy pixels DP2 and the TFT elements of B pixels within the effective display region L are alternately connected along the extending direction of the drain electrode line DL_{3 m+1}. Here, assuming that a write signal is applied to the drain electrode line DL_{3 m+1} from the upper side of the paper surface, with respect to the applied signal, for example, as shown in FIG. 5, a signal which makes the dummy pixels DP2 display black color is applied at timing that the gate signal is applied to the odd-number-numbered gate electrode lines GL₁, GL₃, GL₅ and the signal which is written in the B pixels is applied at timing that the gate signal is applied to the even-numbered gate electrode lines GL₂, GL₄.

Further, for example, with respect to the signal applied to the drain electrode line DL₂, the signal which is written in the G pixels is applied at timing that the gate signal is applied to the odd-number gate electrode lines GL₁, GL₃, GL₅ and the signal which is written in the R pixels is applied at timing that the gate signal is applied to the even-numbered gate electrode lines GL₂, GL₄.

The dummy pixels which are arranged outside the effective display region L are usually shielded by from light by a light shielding layer. Accordingly, a potential which is applied to the dummy pixels is not particularly limited. However, the dummy pixels can surely assume a black state by writing black data in the dummy pixels and hence, it is preferable to such a constitution in view of the constant stabilization of the potential.

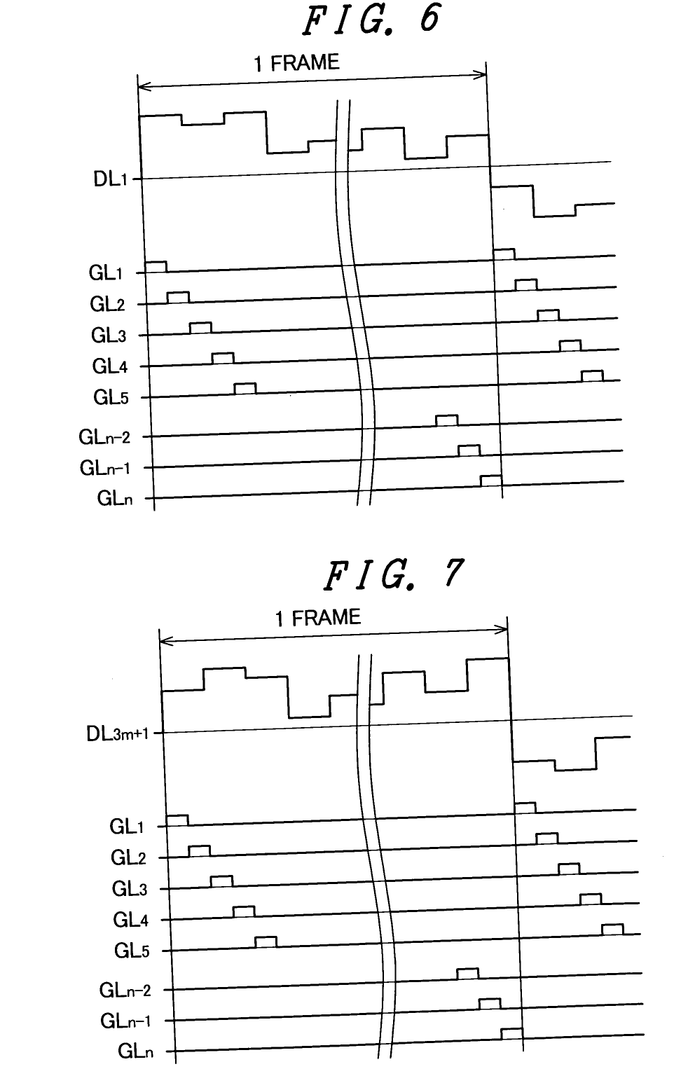

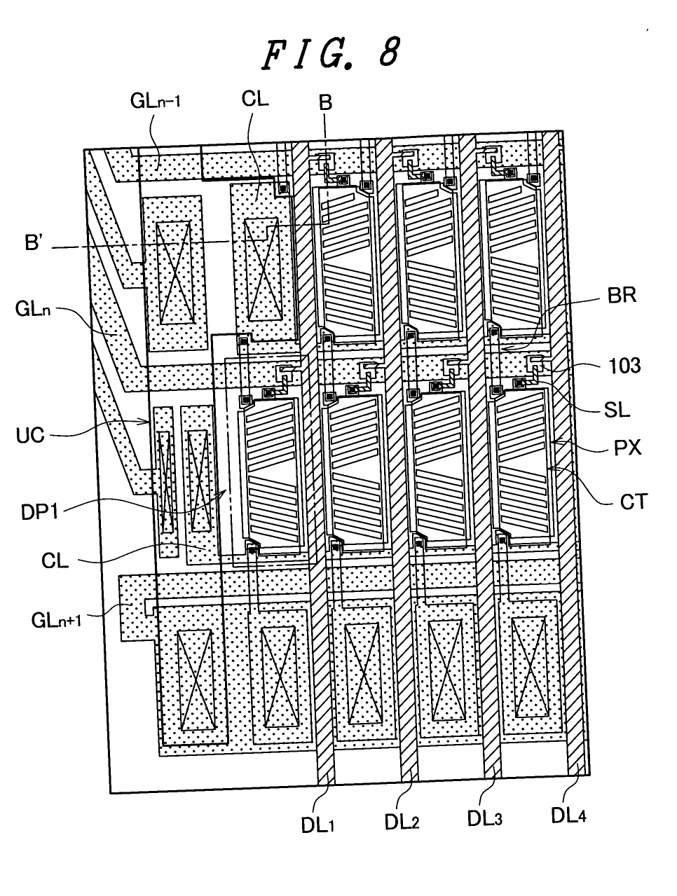

FIG. 6 is a view showing another example of a timing chart of the signal which is applied to the drain electrode line DL₁ of the display panel of this embodiment. Further, FIG. 7 is a view showing another example of a timing chart of the signal which is applied to the drain electrode line DL_{3 m+1} of the display panel of this embodiment.

In this embodiment, in applying a signal to the drain electrode line DL₁, several methods are considered besides the method shown in FIG. 4 which makes the first dummy pixels DP1 to perform the black display. That is, for example, as shown in FIG. 5, a signal equal to the signal written in the one-preceding R pixel maybe applied. In the same manner, in applying a signal to the drain electrode line DL_{3 m+1}, as shown in FIG. 6, for example, a signal equal to a signal written in the one-succeeding B pixel may be applied.

Further, FIG. 6 or FIG. 7 are provided for explaining an example of general signals which are applied to another drain electrode lines within the effective display region L. The control of the operation of the drain electrode lines shown FIG. 6 or FIG. 7 is characterized in that polarity is held stable during one frame period. On the premise of such feature, the pixels which are arranged close to the drain electrode line have the TFT elements thereof alternately connected with the neighboring drain electrode line in the direction of the drain electrode line thus realizing dot inversion as a display. In this manner, the inversion of polarity of the signal per se occurs once for every frame and hence, compared to a conventional dot inversion in which the polarity of the signal is inverted for every line, the number of inversion of the polarity of the signal is sharply reduced to one several hundredth, for example, to 1/768 in XGA. When the polarity of the signal of the drain electrode line is inverted, along with charging and discharging of the drain electrode line, it takes time until the potential of the drain electrode line is stabilized and hence, the effective write time is reduced by an amount of such time. Accordingly, in the conventional dot inversion, it is difficult to write the signal at a high frequency of 100 Hz or more. To the contrary, according to the present invention, the polarity inversion is eliminated during the frame and hence, the charging/discharging time directly contributes to writing whereby it is possible to realize the driving at a high frequency of 100 Hz or more, for example, 120 Hz which is a twofold speed of the input signal of 60 Hz. In such an operation, the dot inversion is maintained with respect to the display image and hence, there arises no drawbacks such as flickering.

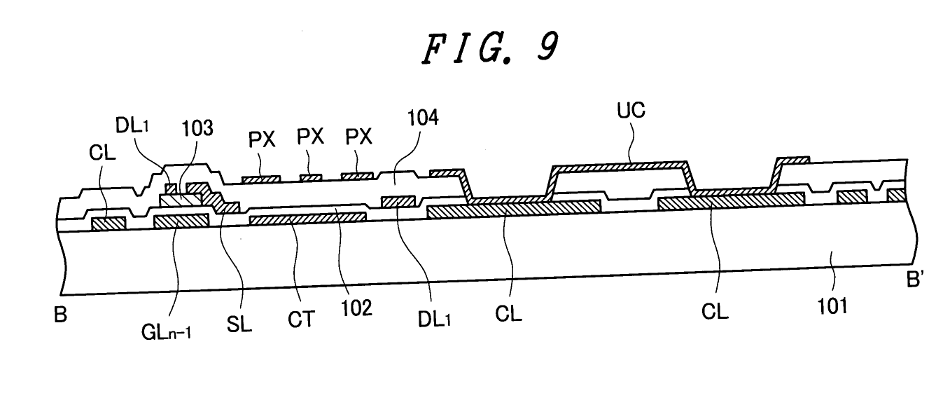

FIG. 8 and FIG. 9 are schematic views showing a constitutional example of a TFT substrate to which the circuit constitution of the embodiment is applied, wherein FIG. 8 is an enlarged plan view of an end portion of an effective display region and FIG. 9 is a cross-sectional view taken along a line B-B′ in FIG. 8. Here, FIG. 8 shows an example in which the number n of the gate electrodes is set to an even number.

A TFT substrate 1 in the circuit constitution of this embodiment, that is, in the circuit constitution shown in FIG. 3 adopts the constitution shown in FIG. 8 and FIG. 9, for example. Here, in FIG. 8, a region which is surrounded by a chain double-dashed line constitutes a left-side dummy pixel DP1. A portion marked with “x” in a quadrangular shape in FIG. 8 indicates a contact hole.

Here, with respect to the TFT substrate 1, gate electrode lines GL, common signal lines CL and common electrodes CT which are connected with a common signal line CL are formed on the glass substrate 101. Further, a semiconductor layer 103, a drain electrode line DL and a source electrode SL are formed over the gate electrode line GL by way of a first inter layer insulation film 102. Here, each drain electrode line DL is, as shown in FIG. 8, bifurcated to be alternately connected with a semiconductor layer 103 which is arranged on a right side of a pixel and a semiconductor layer 103 which is arranged on a left side of a pixel.

Further, in a region on the left side of the drain electrode line DL₁, between the drain electrode lines DLₙ₋₁ and the gate electrode line GLₙ, a TFT element is not formed but a planner electrode of the common signal line CL having a common potential is formed. Due to such a constitution, a black display is performed thus realizing the stabilization of the potential of the region. Further, between the gate electrode line GLₙ and the gate electrode line GLₙ₊₁, a dummy pixel electrode to which a signal is supplied from a TFT element which is connected with the drain electrode line DL₁ is formed. This pixel performed a black display when black data is applied to the pixel as shown in FIG. 4 and FIG. 5.

Further, above-mentioned the drain electrode line DL or the like, in a display region, pixel electrodes PX and bridge lines BR which connect the common electrodes CT of the vertically neighboring pixels are arranged while interposing a second interlayer insulation film 104. Further, in a dummy region, an electrode UC of a common potential and the bridge line BR which connects the common electrodes CT of the vertically neighboring pixels are formed. Here, the pixel electrode PX is connected with the above-mentioned source electrode SL via a through hole. Further, for example, slits are formed in the pixel electrode PX. On the other hand, the electrode UC of the common potential is connected with a common signal line CL via a through hole. Due to such a constitution, the electrode UC plays a role of a bus line of the common signal lines. Further, the above-mentioned bridge line BR is connected with the common electrode CT of the above-mentioned each pixel via the through hole.

Here, FIG. 8 and FIG. 9 are views showing one example of the constitution of the TFT substrate 1, wherein it is needless to say that the constitutions of the TFT element, the pixel electrode PX, the common electrode CT and the like can be suitably changed.

As has been explained above, according to the liquid crystal display panel of this embodiment, it is possible to reduce the deterioration of the image quality attributed to the enhancement of the refresh rate.

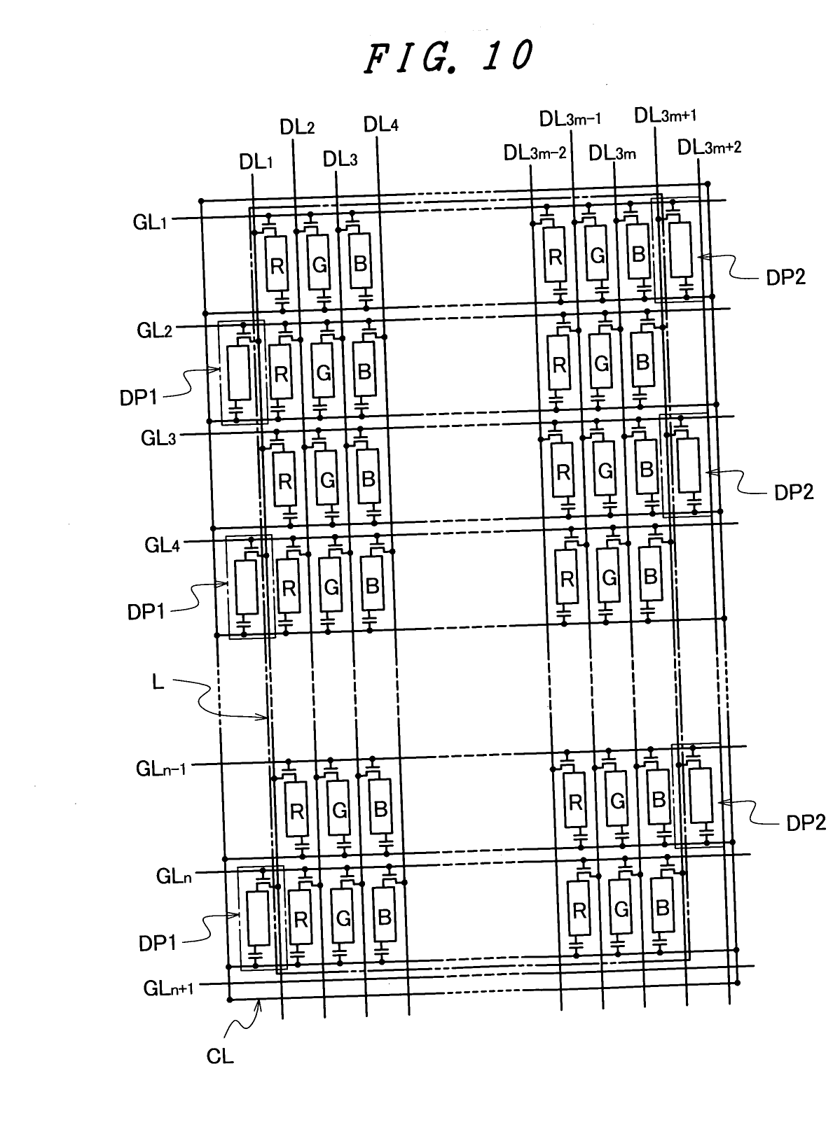

FIG. 10 is a schematic view for explaining a first modification of the embodiment and also is a view showing the circuit constitution of a TFT substrate.

In the above-mentioned embodiment, as shown in FIG. 3, the number of drain electrode lines DL is 3 m+1. However, the number of drain electrode line DL is not limited to such a number and, for example, as shown in FIG. 10, another dummy drain electrode line DL_{3 m+2} may be provided outside the second dummy pixels DP2.

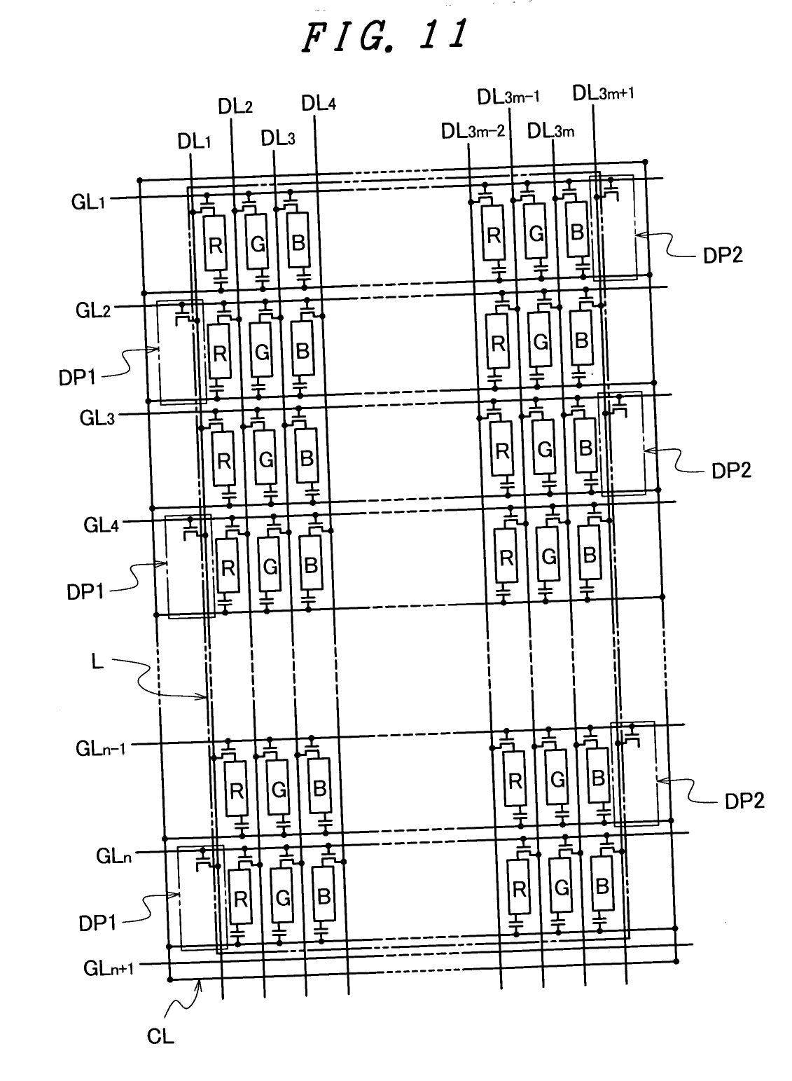

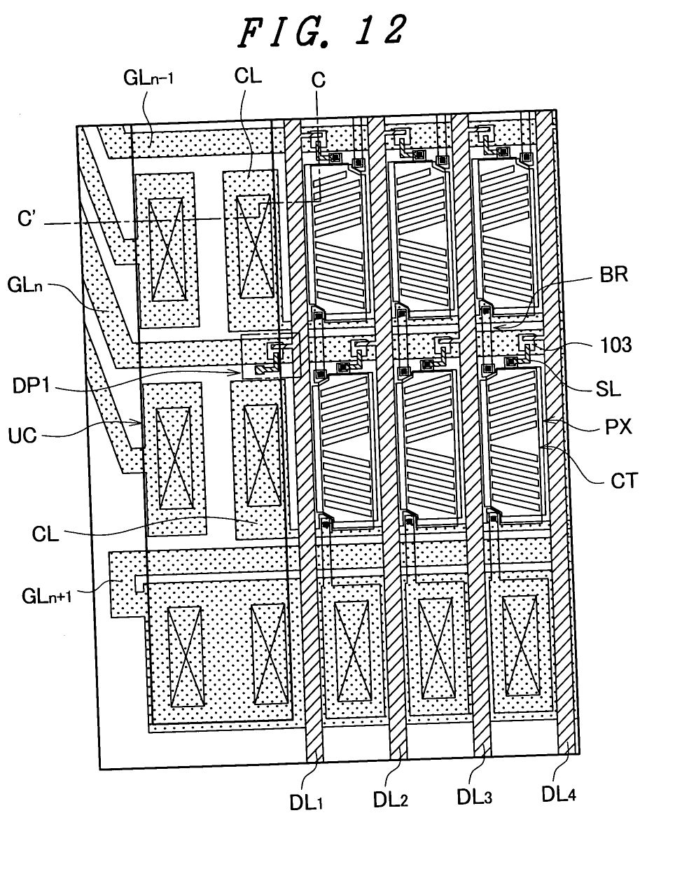

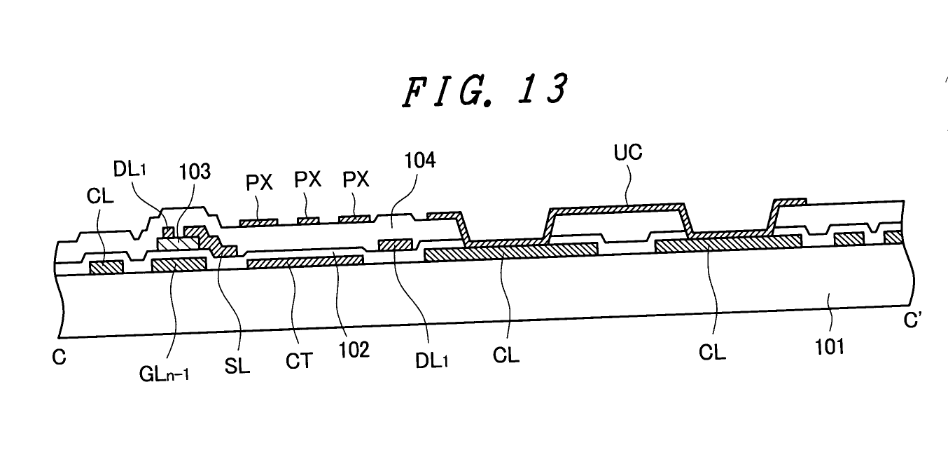

FIG. 11 to FIG. 13 are schematic views for explaining a second modification of the embodiment, wherein FIG. 11 is a view showing the circuit constitution of a TFT substrate, FIG. 12 is an enlarged plan view showing a constitutional example of the TFT substrate to which the circuit constitution shown in FIG. 11 is applied, and FIG. 13 is a cross-sectional view taken along a line C-C′ in FIG. 12.

In the above-mentioned embodiment, as shown in FIG. 3, as the first and second dummy pixels DP1, DP2, dummy pixels having the same constitution as pixels within the effective display region L are arranged. However, the arrangement of the dummy pixels is not limited to such a constitution and, for example, as shown in FIG. 11, only TFT elements may be arranged as the dummy pixels DP1, DP2. This is because that a load capacitance of the drain electrode line is mainly occupied by a capacitance of the TFT element. Here, the circuit constitution shown in FIG. 11 is equal to the circuit constitution shown in FIG. 3 except for the point that the first and second dummy pixels DP1, DP2 are constituted of only the TFT element.

The TFT substrate 1 to which the circuit constitution shown in FIG. 11 is applied adopts the constitution shown in FIG. 12 and FIG. 13, for example. Here, in FIG. 12, a region which is surrounded by a chain double-dashed line in FIG. 12 indicates a TFT element of the first dummy element DP1. Further, the constitution of the TFT substrate 1 shown in FIG. 12 and FIG. 13 is characterized by forming the first dummy pixel DP1 surrounded by the chain double-dashed line in FIG. 8 using only the TFT element, and as a constitution is equal to the corresponding constitution shown in FIG. 8 and FIG. 9. Further, FIG. 12 and FIG. 13 also shows an example of the constitution of the TFT substrate and hence, it is needless to say that the constitutions of the TFT element, the pixel electrode PX and the common electrode CT and the like can be suitably changed.

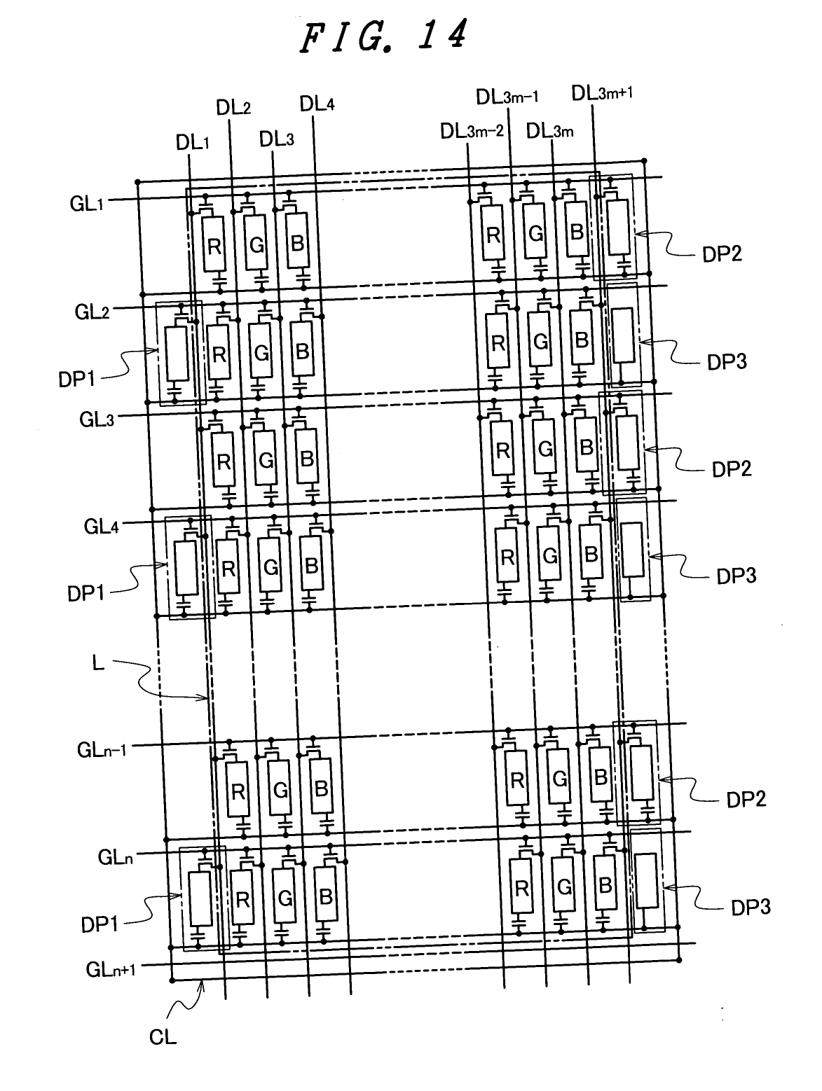

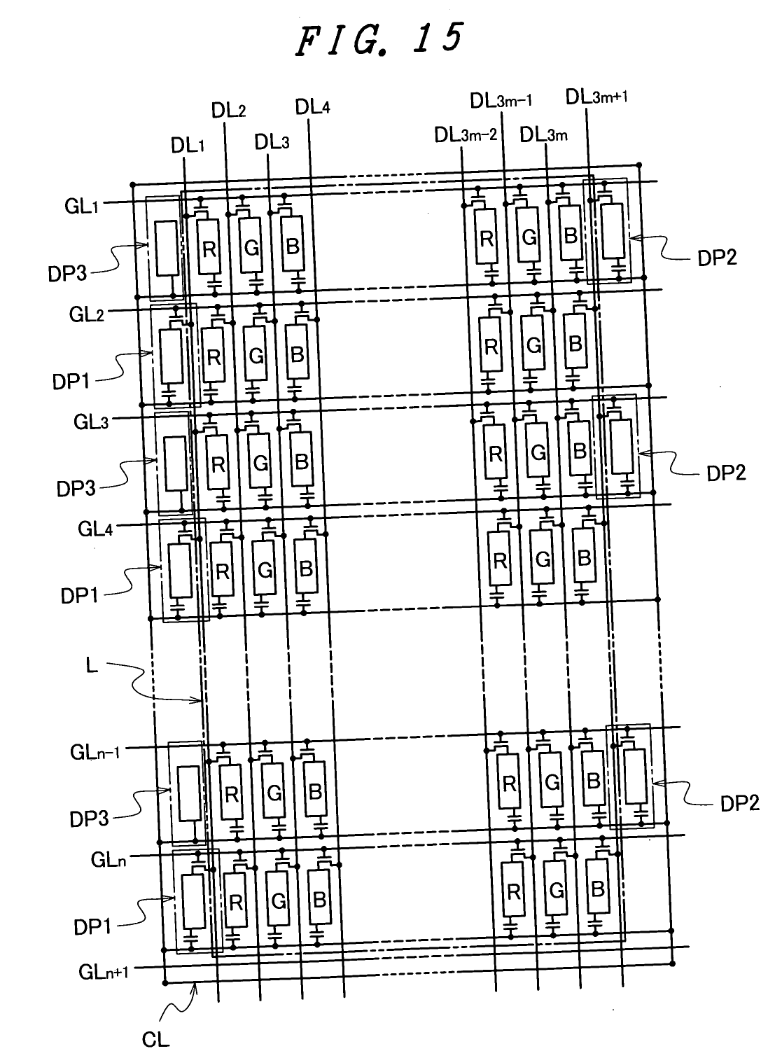

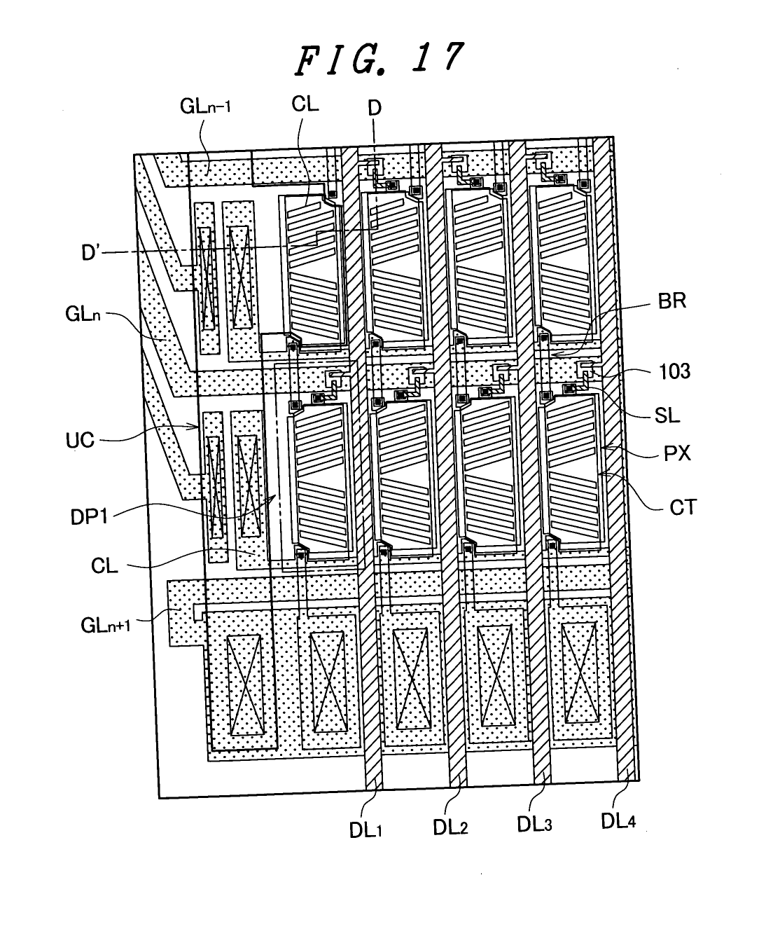

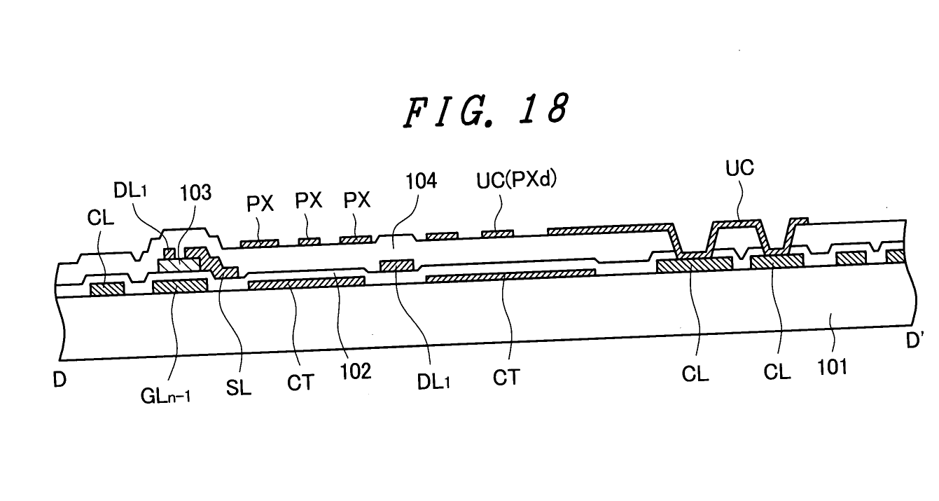

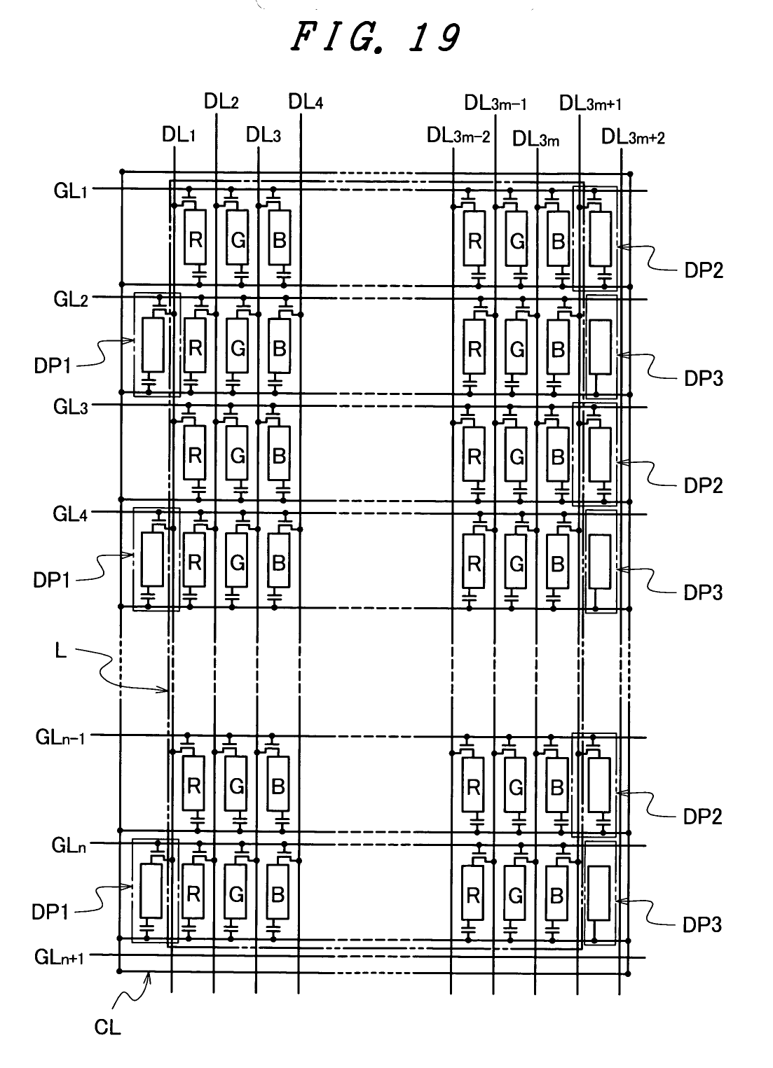

FIG. 14 to FIG. 18 are schematic views for explaining a third modification of the embodiment, wherein FIG. 14 to FIG. 16 are views showing the circuit constitution of a TFT substrate respectively, FIG. 17 is an enlarged plan view showing a constitutional example of the TFT substrate to which the circuit constitution shown in FIG. 15 is applied, and FIG. 18 is a cross-sectional view taken along a line C-C′ in FIG. 17.

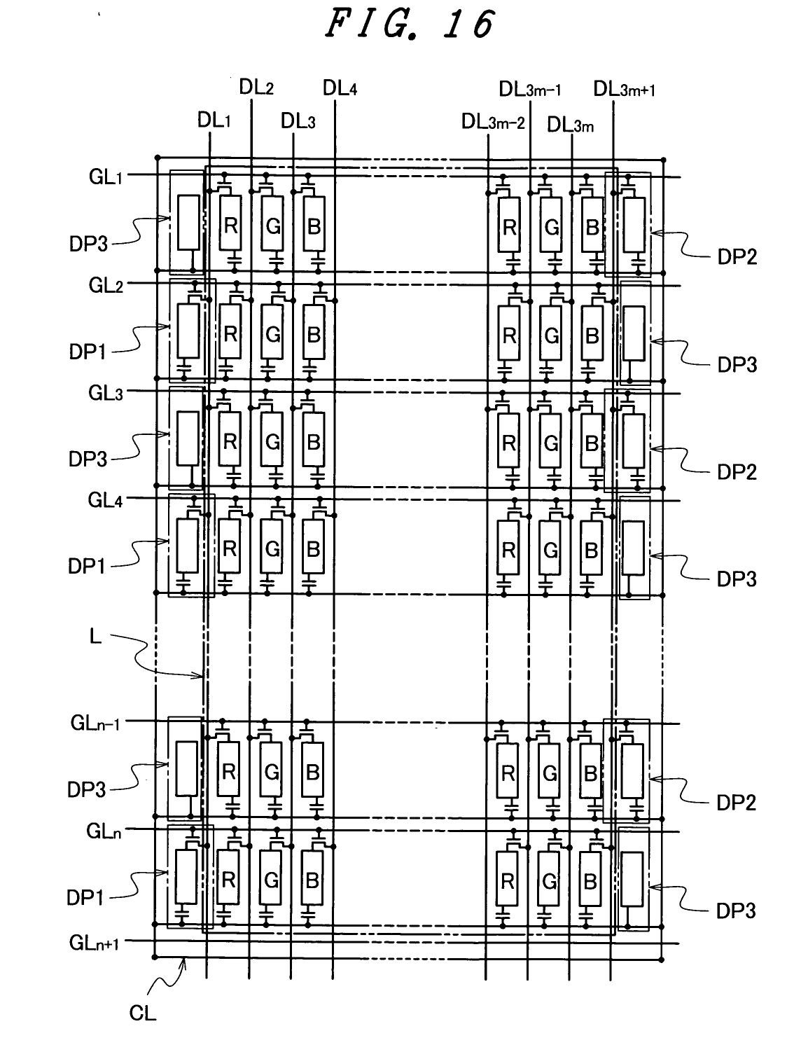

In the explanation made heretofore, for example, as shown in FIG. 3, the dummy pixels DP1, DP2 are arranged on the even-numbered drain electrode lines or the odd-numbered drain electrode lines. However, in the display device of the present invention, for example, as shown in FIG. 14, a third dummy pixel DP3 may be arranged between the second dummy pixels DP2. Here, the third dummy pixel DP3 is, different from the second dummy pixel DP2, constituted of only a dummy electrode which is connected with a common signal line CL, for example. Further, the third dummy pixel DP3 may be, for example, as shown in FIG. 15, arranged between the first dummy pixels DP1 or, as shown in FIG. 16, the third dummy pixel DP3 may be arranged between the first dummy pixels DP1 as well as between the second dummy pixels DP2.

One example of a case in which such a constitution, for example, the circuit constitution shown in FIG. 15 is adopted is shown in FIG. 17 and FIG. 18. For example, as shown in FIG. 17 and FIG. 18, as the third dummy pixel DP3, a dummy pixel electrode may be formed on the same layer as the pixel electrode PX of the pixel within the effective display region integrally with an electrode UC of a common potential. Due to such a constitution, the dummy pixel having the pixel electrode as an uppermost layer and the dummy pixel having the common electrode as the uppermost layer are arranged every one other. Further, slits are formed in both of the pixel electrode which constitutes the uppermost layer and the common electrode which constitutes the uppermost layer.

Due to such a constitution, for example, between the first dummy pixels DP1 which are arranged every one other and the dummy pixel DP3 which is arranged between the first dummy pixels DP1, it is possible to make the difference of the step structure small. Accordingly, for example, in a rubbing step for forming an orientation film on the TFT substrate 1, it is possible to obviate the generation of irregularities of a rubbing strength attributed to the above-mentioned step.

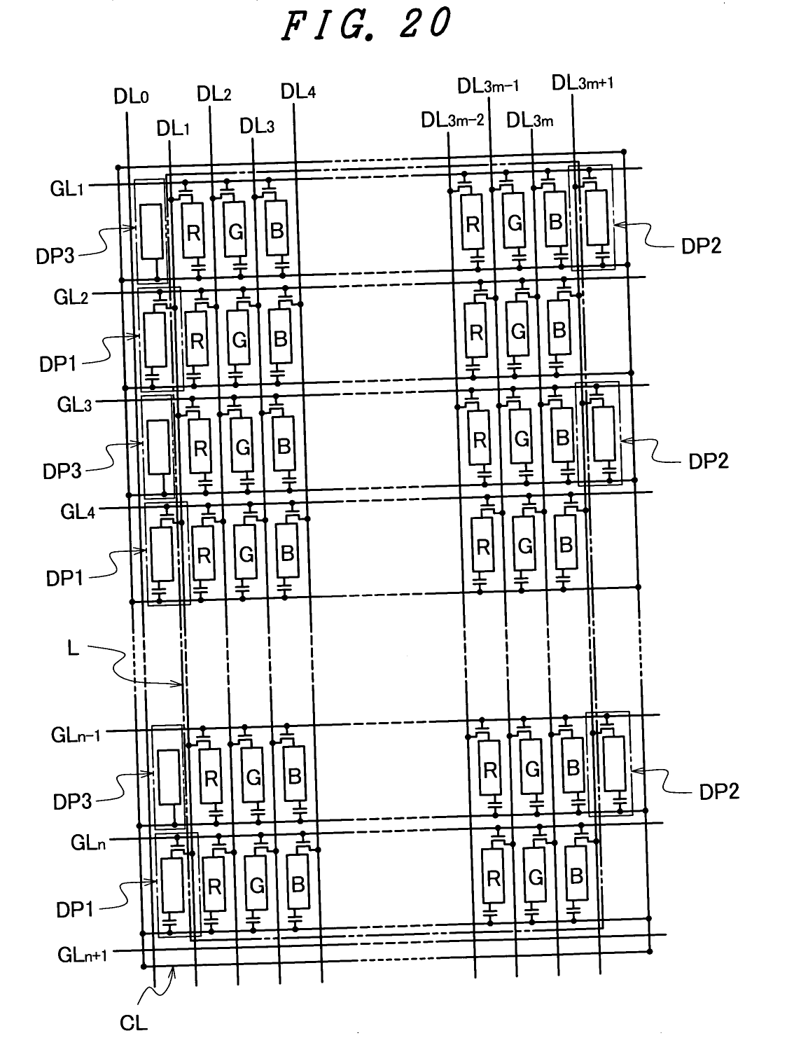

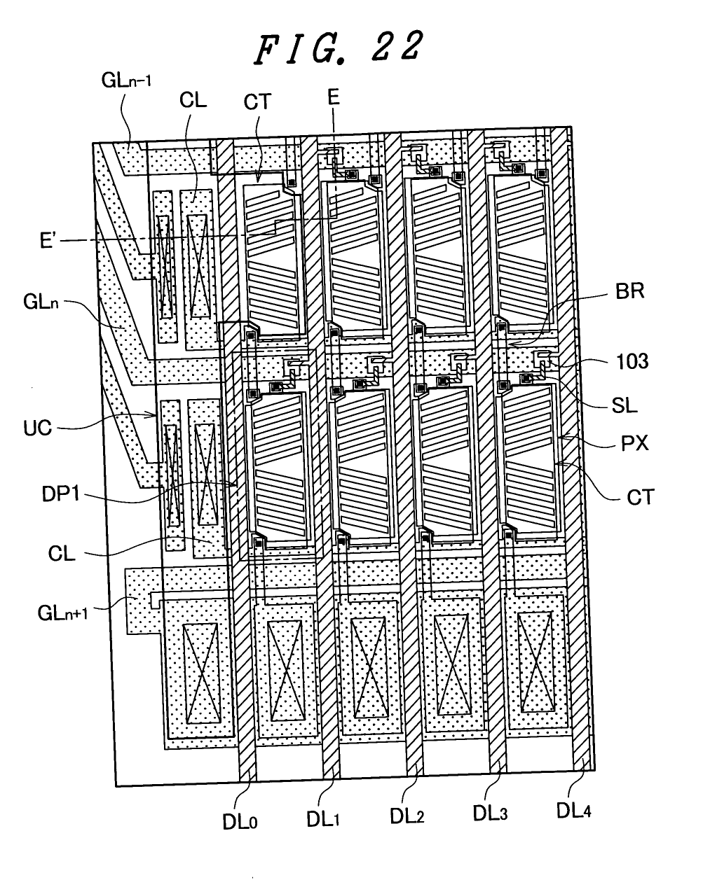

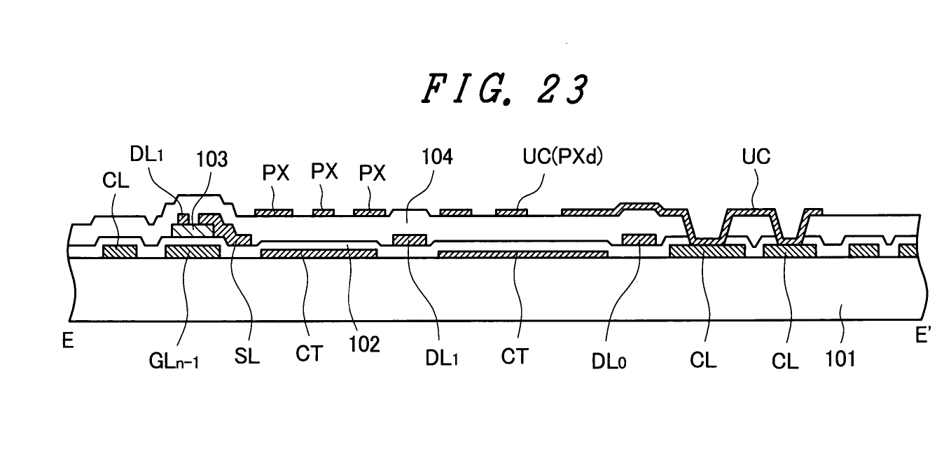

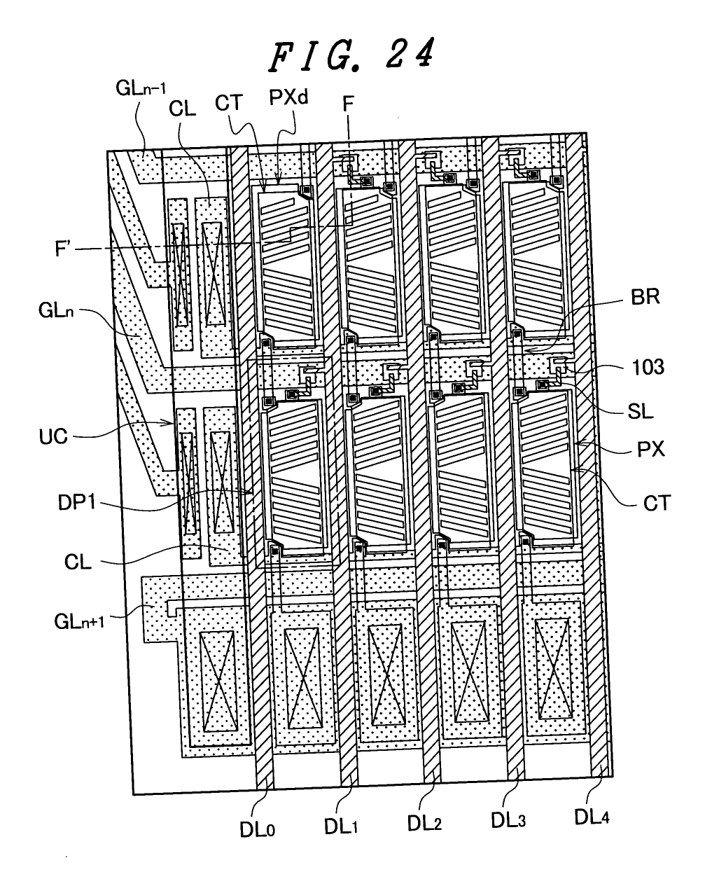

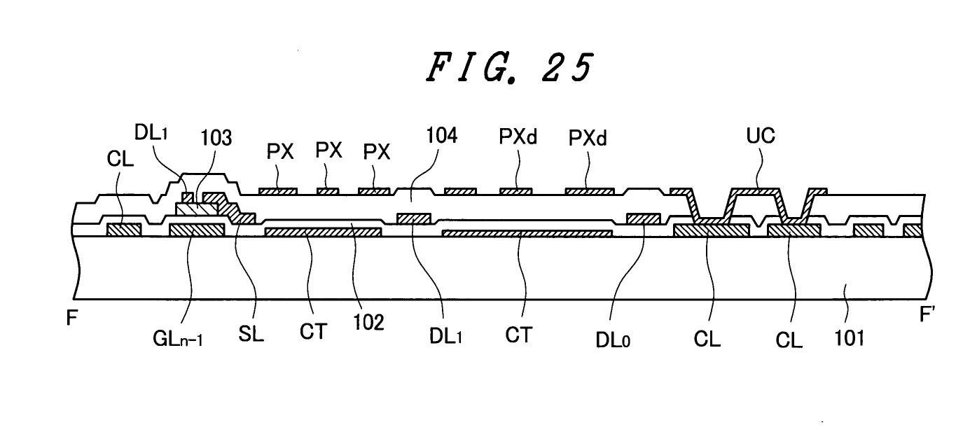

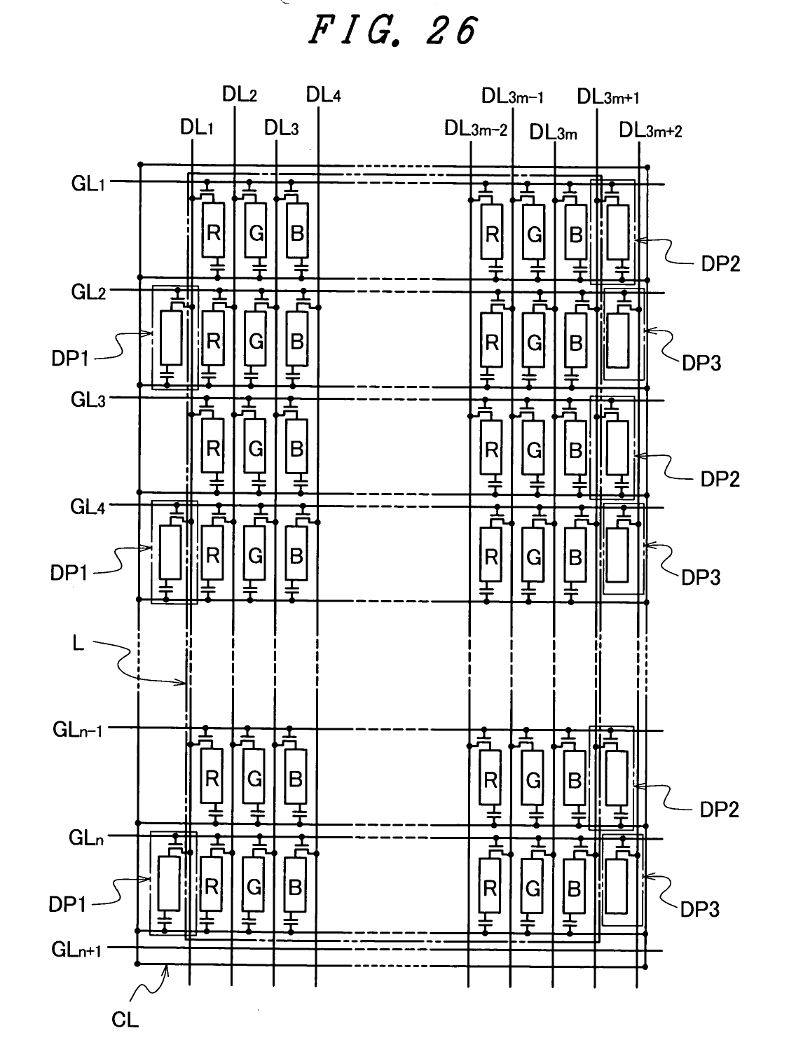

FIG. 19 to FIG. 25 are schematic views for explaining a fourth modification of the embodiment, wherein FIG. 19 to FIG. 21 are views showing the circuit constitution of a TFT substrate respectively, FIG. 22 is an enlarged plan view showing a constitutional example of the TFT substrate to which the circuit constitution shown in FIG. 20 is applied, FIG. 23 is a cross-sectional view taken along a line D-D′ in FIG. 22, FIG. 24 is an enlarged plan view showing a constitutional example of the TFT substrate to which the circuit constitution shown in FIG. 20 is applied, and FIG. 25 is a cross-sectional view taken along a line F-F′ in FIG. 24.

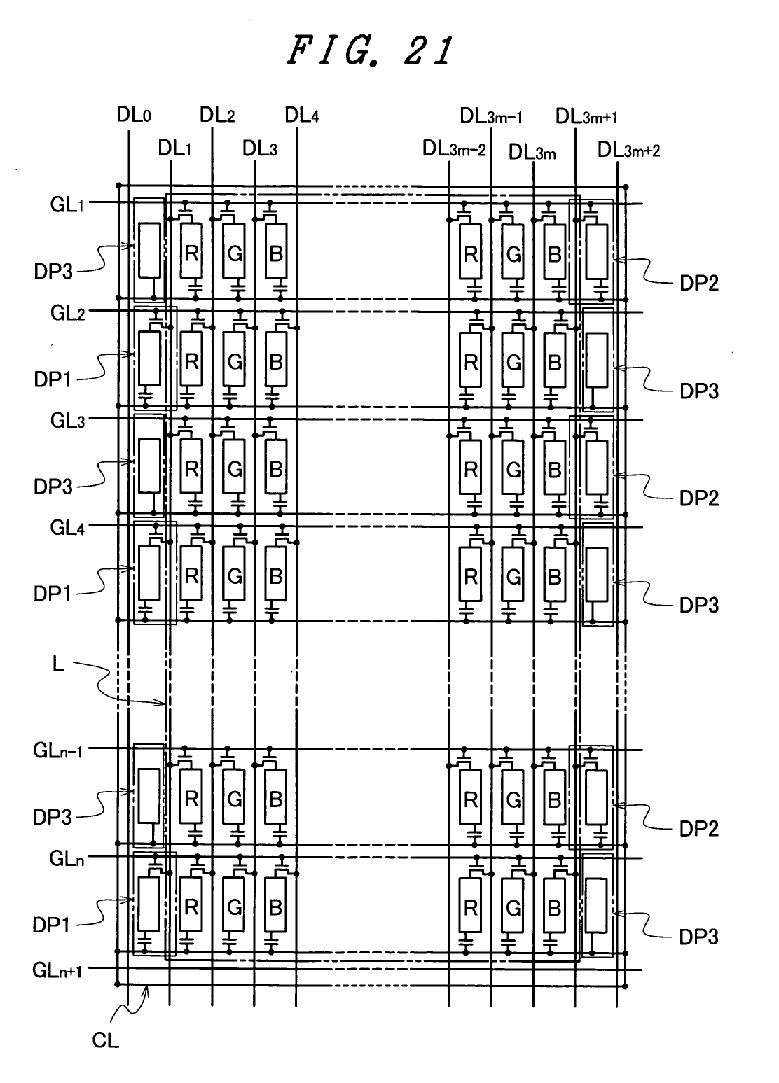

FIG. 14 to FIG. 18 shows the circuit constitution which used the circuit constitution shown in FIG. 3 as the basic constitution and arranges the third dummy pixel DP3 between the first dummy pixels DP1, between the second dummy pixels DP2, or between the first dummy pixels DP1 as well as between the second dummy pixels DP2. However, in arranging the third dummy pixel DP3 as shown in FIG. 19, the third dummy pixel DP3 is arranged only between the second dummy pixels DP2 and, further, a dummy drain electrode DL_{3 m+2} may be arranged outside the second dummy pixels DP2 and the third dummy pixels DP3, for example. Further, for example, as shown in FIG. 20, the third dummy pixel DP3 may be arranged only between the first dummy pixels DP1 and, further, a dummy drain electrode DL₀ may be arranged outside the first dummy pixels DP1 and the third dummy pixels DP3. Further, by combining these constitutions, for example, as shown in FIG. 21, the third dummy pixel DP3 may be arranged between the first dummy pixels DP1 as well as between the second dummy pixels DP2 and, further, drain electrode lines DL₀, DL_{3 m+2} may be arranged outside the first dummy pixels DP1, the second dummy pixels DP2 and the third dummy pixels DP3.

An example of a case in which such a constitution, for example, the constitution shown in FIG. 20 is adopted is shown in FIG. 22 and FIG. 23. In the third dummy pixel DP3, for example, as shown in FIG. 22 and FIG. 23, a dummy pixel electrode PXd is formed on the same layer as a pixel electrode PX of a pixel within an effective display region integrally with an electrode UC of a common potential. Due to such a constitution, for example, it is possible to make the difference of the step structure between the first dummy pixels which are arranged every one other and the third dummy pixel which is arranged between the first dummy pixels small. Accordingly, for example, in a rubbing step for forming an orientation film on the TFT substrate 1, it is possible to obviate the generation of irregularities of a rubbing strength attributed to the above-mentioned step.

Further, in adopting the circuit constitution shown in FIG. 20, the dummy pixel electrode PXd formed on the third dummy pixel DP3 may be set to a common potential by integrally forming the dummy pixel electrode PXd with the bridge line BR as shown in FIG. 24, for example, thus connecting the dummy pixel electrode PXd with the common electrode CT of the first dummy pixel DP1.

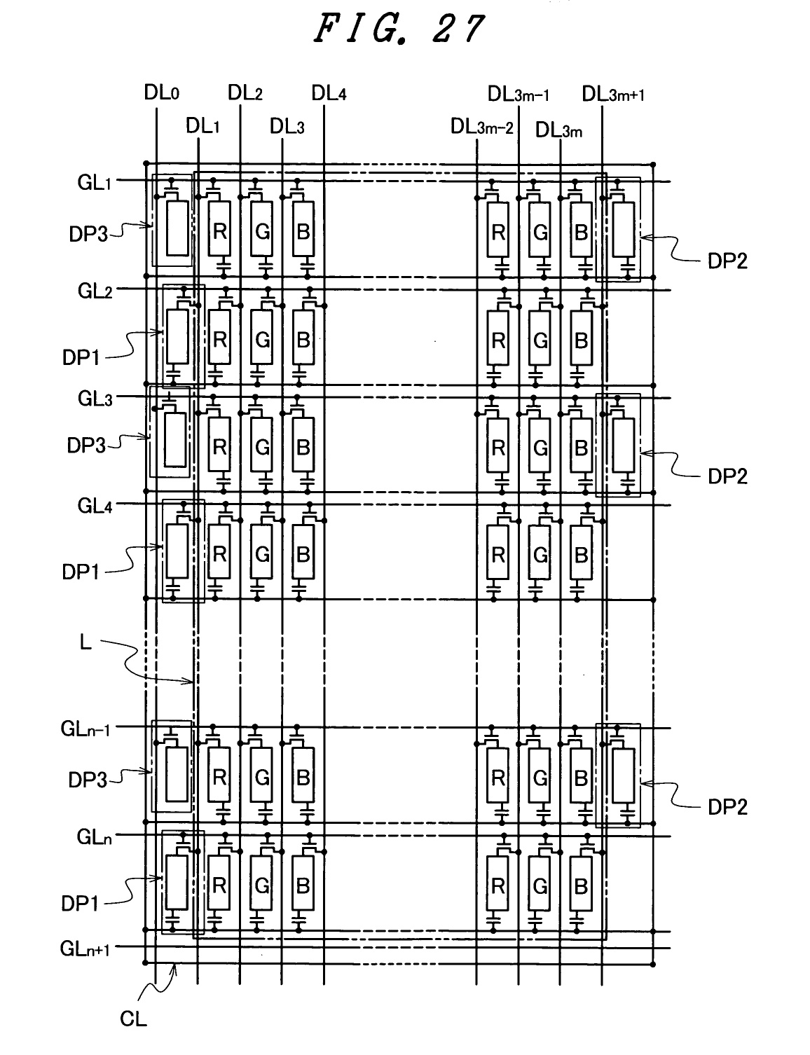

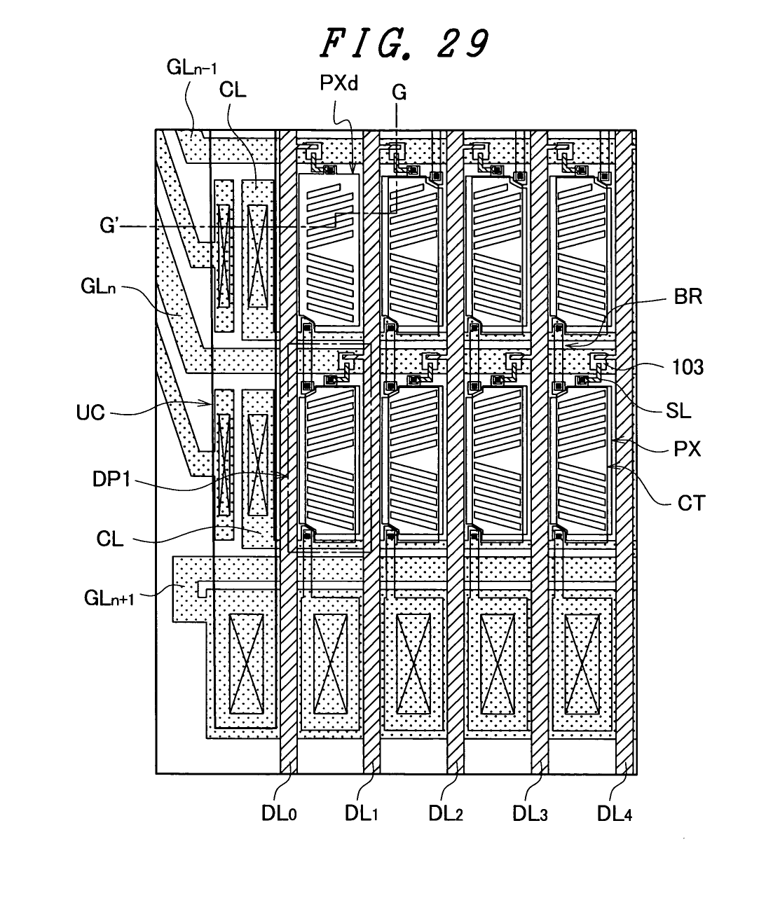

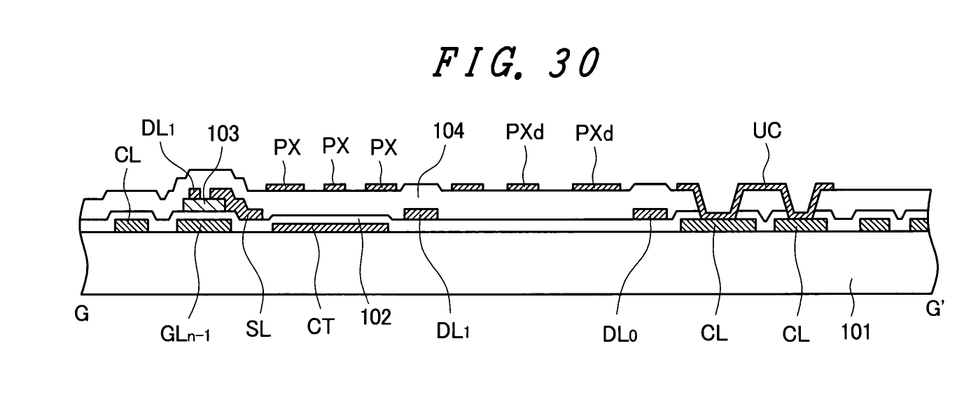

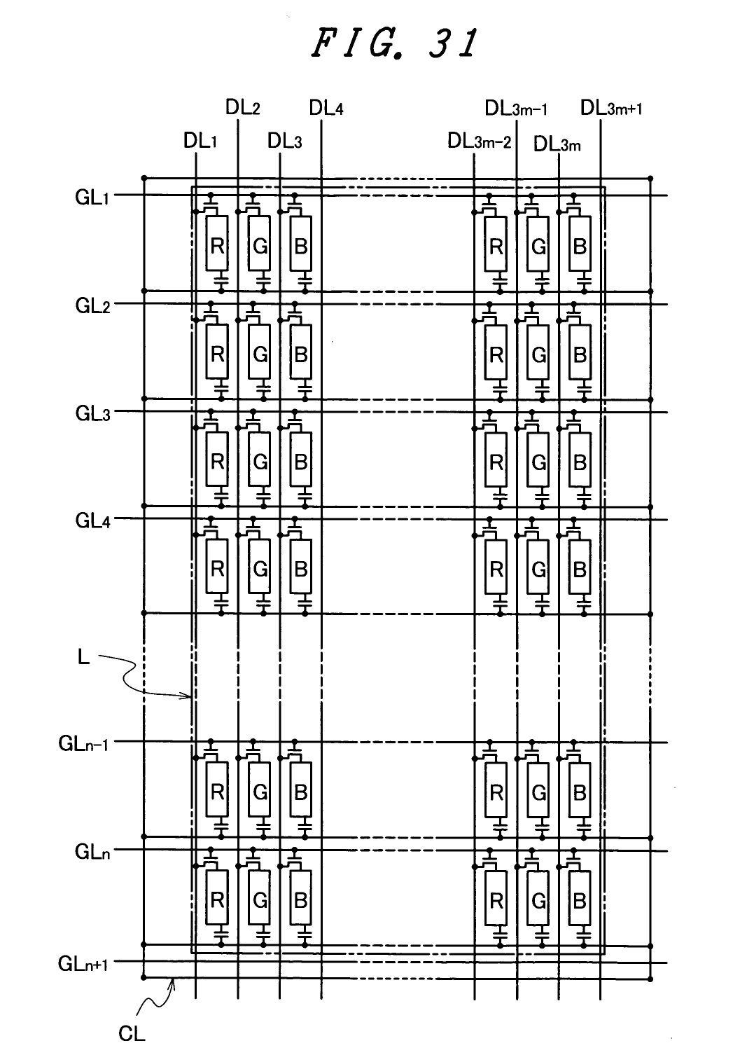

FIG. 26 to FIG. 30 are schematic views for explaining a fifth modification of the embodiment, wherein FIG. 26 to FIG. 28 are views showing the circuit constitution of a TFT substrate respectively, FIG. 29 is an enlarged plan view showing a constitutional example of the TFT substrate to which the circuit constitution shown in FIG. 27 is applied, and FIG. 30 is a cross-sectional view taken along a line G-G′ in FIG. 29.

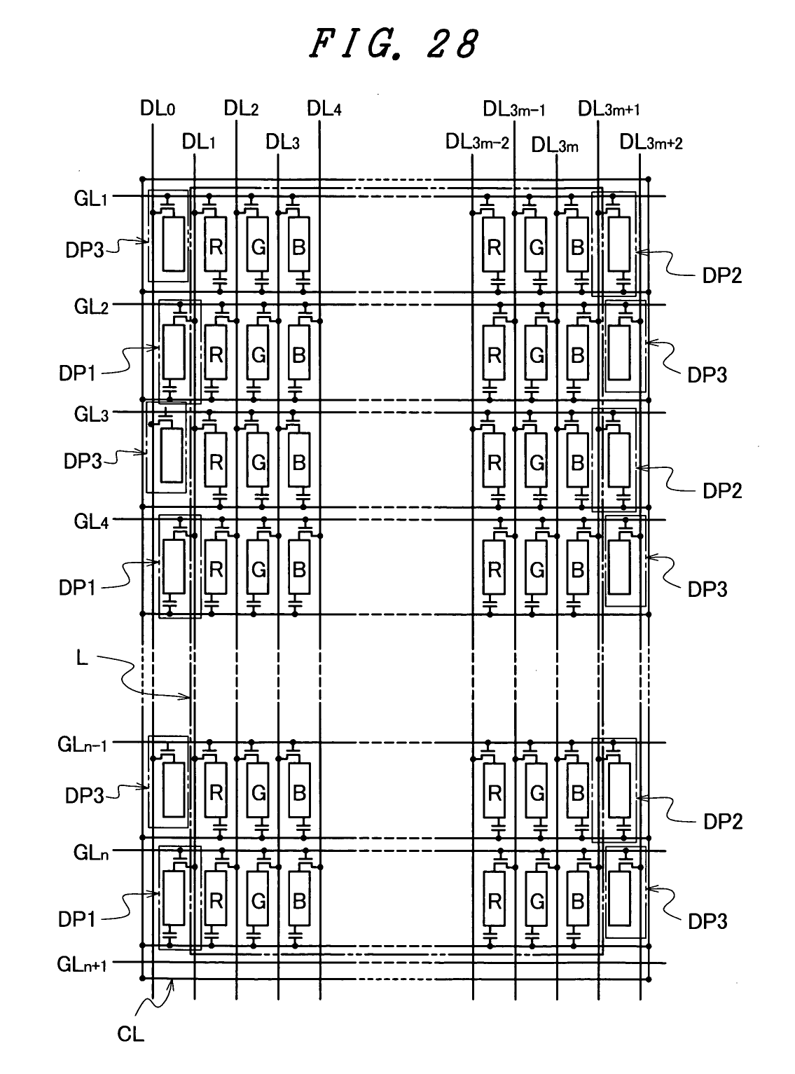

In the above-mentioned third and fourth modifications, an example in which the pixel electrode PXd of the common potential is formed as the third dummy pixel DP3 is exemplified. However, the third dummy pixel DP3 is not limited to such a constitution and, for example, as shown in FIG. 26, only the TFT element and the pixel electrode may be arranged between the second dummy pixels DP2. Here, the dummy drain electrode line DL_{3 m+2} is arranged outside the second dummy pixel DP2 and the TFT element of the third dummy pixel DP3 is connected with the dummy drain electrode line DL_{3 m+2} Further, for example, as shown in FIG. 27, the third dummy pixel DP3 may be arranged only between the first dummy pixels DP1 and, further, the dummy drain electrode DL₀ may be arranged outside the first dummy pixels DP1 and the dummy pixels DP3. Still further, by combining these constitutions, for example, as shown in FIG. 28, the third dummy pixel DP3 may be arranged between the first dummy pixels DP1 as well as between the second dummy pixels DP2 and, further, the drain electrode lines DL₀, DL_{3 m+2} may be arranged respectively outside the first dummy pixels DP1, the second dummy pixels DP2 and the third dummy pixels DP3.

An example of a case in which such a constitution, for example, the circuit constitution shown in FIG. 27 is adopted is shown in FIG. 29 and FIG. 30. In the third dummy pixel DP3, a dummy pixel electrode PXd is formed on the same layer as the pixel electrode PX of the pixel within an effective display region as shown in FIG. 29 and FIG. 30, for example. Here, the common electrode CT which is overlapped with the dummy pixel electrode PXd is not formed. Due to such a constitution, for example, it is possible to make the difference of the step structure between the first dummy pixels DP1 which are arranged every one other and the third dummy pixel DP3 which is arranged between the first dummy pixels small. Accordingly, for example, in a rubbing step for forming an orientation film on the TFT substrate 1, it is possible to obviate the generation of irregularities of a rubbing strength attributed to the above-mentioned step.

Although the present invention has been specifically explained in conjunction with the embodiment, it is needless to say that the present invention is not limited to the above-mentioned embodiment and various modifications are conceivable without departing from the gist of the present invention.

For example, in the above-mentioned embodiments and modifications, the example which uses the TFT substrate 1 of the liquid crystal display panel shown in FIG. 1 and FIG. 2 is exemplified. However, the present invention is not limited to the above-mentioned liquid crystal display panel and the present invention is applicable to various display panels in which the TFT element is arranged for each pixel.

1. A display device including a display panel on which a TFT element and a pixel electrodes are arranged for each pixel, wherein
the display panel arranges, outside one end portion of an effective display region in the extending direction of gate electrode lines out of end portions of the effective display region, first dummy pixels having TFT elements which are connected with the even-numbered gate electrode lines counted from one end portion of the effective display region in the extending direction of drain electrode lines,
the display panel arranges, outside another end portion of the effective display region in the extending direction of gate electrode lines out of the end portions of the effective display region, second dummy pixels having TFT elements which are connected with the odd-numbered gate electrode lines counted from the one end portion of the effective display region in the extending direction of the drain electrode lines, and
the TFT elements of the respective pixels which are arranged on both sides of the drain electrode line are alternately connected with each drain electrode line in the extending direction of the drain electrode line, and
the TFT elements which are arranged in the inside of the effective display region and the first or the second dummy pixels are alternately connected with each drain electrode line at the end portion of the effective display region in the extending direction of the gate electrode lines along the extending direction of the drain electrode line.

2. A display device according to claim 1, wherein the end portion of the effective display region on which the first dummy pixels are arranged constitutes an input end side of the gate electrode lines.

3. A display device according to claim 1, wherein the first and the second dummy pixels have the same constitution as the pixels within the effective display region.

4. A display device according to claim 1, wherein the first and the second dummy pixels include only the TFT elements.

5. A display device according claim 1, wherein a dummy drain electrode line is provided outside the first or the second dummy pixels.

6. A display device according to claim 1, wherein a third dummy pixel is arranged between the first dummy pixels or between the second dummy pixels.

7. A display device according to claim 6, wherein the third dummy pixel has a dummy electrode layer on a same conductive layer as the pixel electrodes of the pixels within the effective display region.

8. A display device according to claim 7, wherein the third dummy pixel includes a TFT element which is connected with the dummy drain electrode line and the dummy electrode layer.

9. A display device in which a plurality of drain electrode lines and a plurality of gate electrode lines are arranged in a matrix array, a pixel region is defined at a portion which is surrounded by two neighboring drain electrode lines and two neighboring gate electrode lines, each pixel region includes a TFT element, and a mass of pixel regions form a display region, wherein
each time the drain electrode line traverses the gate electrode line in the extending direction of the drain electrode line, the arrangement direction of TFT elements with respect to the drain electrode line is inverted, and
a TFT element is arranged outside the display region each time the drain electrode line traverses two gate electrode lines.

10. A display device according to claim 9, wherein a region where the TFT element is arranged each time the drain electrode line traverses two gate electrode lines is shielded from light.

11. A display device according to claim 9, wherein a region where the TFT element is arranged each time the drain electrode line traverses two gate electrode lines is displaced from each other between the left outside and the right outside of the display region by an amount corresponding to one gate electrode line.

12. A display device according to claim 9, wherein a signal having the same polarity is applied to the drain electrode line during 1 frame period.

13. A display device according to claim 12, wherein signals having polarities opposite to each other are applied to two neighboring drain electrode lines.

14. A display device in which a plurality of drain electrode lines and a plurality of gate electrode lines are arranged in a matrix array, a pixel region is defined at a portion which is surrounded by two neighboring drain electrode lines and two neighboring gate electrode lines, each pixel region includes a TFT element, and a mass of pixel regions form a display region, wherein
each time the drain electrode line traverses the gate electrode line in the extending direction of the drain electrode line, the arrangement direction of TFT elements with respect to the drain electrode line is inverted, and
a signal of the same polarity is applied to the drain electrode line during 1 frame period, and signals having polarities opposite to each other are applied to two neighboring drain electrode lines.
